(19) United States
(12) Patent Application Publication
(10) Pub. No.: US 2009/0109833 A1
(43) Pub. Date: Apr. 30, 2009

(54) PRINTABLE OPTICAL DISC AND MANUFACTURING METHOD THEREOF

(75) Inventor: Chen Peng, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: DAXON TECHNOLOGY INC., Taoyuan (TW)

(21) Appl. No.: 12/203,928

(22) Filed: Sep. 4, 2008

(30) Foreign Application Priority Data
Oct. 24, 2007 (TW) 96139847

(51) Int. Cl. G11B 7/26; B32B 37/12

(52) U.S. Cl. 369/283; 156/277; 156/242; 156/273.1; 156/275.5; 428/65.2; G9B/7.194

(57) ABSTRACT

A printable optical disc including an optical disc body, a waterproof protective film, and a first patterned layer is provided. The optical disc body has a printable surface. The waterproof protective film has an upper surface and a lower surface. The lower surface is disposed on the printable surface, and the upper surface has an optical grating pattern or a pixel pattern. The first patterned layer is disposed between the lower surface of the waterproof protective film and the printable surface.

### CROSS-REFERENCE TO RELATED APPLICATION

This application claims the priority benefit of Taiwan application serial no. 96139847, filed on Oct. 24, 2007. The entirety of the above-mentioned patent application is hereby incorporated by reference herein and made a part of this specification.

### BACKGROUND OF THE INVENTION

1. Field of the Invention

The present invention relates to an optical disc and a manufacturing method thereof, in particular, to a printable optical disc and a manufacturing method thereof.

2. Description of Related Art

Optical storage media advantageous in having large storage capacity, convenience in keeping, long shelf life, low cost, and data being not easily damaged have gradually replaced conventional magnetic storage media to become one of the indispensable media in the modern life. With gradual maturation of the technology of manufacturing laser photoelectric products and multimedia audio-visual compression technology, the optical storage media are developing toward large capacity, high recording density, and small size.

Generally, the optical storage media can be classified into compact disc (CD) and digital versatile disc (DVD). DVD is the mainstream of the current optical information recording media. However, with the popularization of multimedia application information, many large files include texts, voices, and images, and thus the capacity of the conventional DVD fails to meet the audio-visual requirements of the next generation. Therefore, in order to more effectively expand the capacity of the discs, blu-ray disc (BD) which loads data with a blue laser and has a recording capacity of above 25 GB has been developed in recent years.

An optical storage medium usually has a reading surface and a printing surface. Generally, after manufacturing an optical storage medium, delicate patterns or trademarks and texts are often printed on the printing surface to attract consumers. Further, consumers tend to print patterns on the printing surfaces by themselves in recent years, for example, on HP Light-Scribe and inkjet printable discs. As for HP Light-Scribe, patterns are carved on disc surfaces, and the formed patterns only have two colors, i.e., black and white. As for inkjet printable disc, patterns are printed on disc surfaces, and the printed patterns have diversified colors. Therefore, the inkjet printable discs are more favored in the market and can be manufactured in a simple way.

However, as water-based ink is used for manufacturing the inkjet printable discs, favourable ink-fixing property is required during printing in order to print out high-quality patterns, and the printed patterns should be able to well resist air humidity so as not to deliquesce. Therefore, many conflicts are caused in order to satisfy the above two requirements.

### SUMMARY OF THE INVENTION

Accordingly, the present invention is directed to a printable optical disc, so as to solve the problem of printed pattern deliquescence.

The present invention is further directed to a method of manufacturing a printable optical disc, so as to provide waterproof protection and obtain three-dimensional printed patterns.

A printable optical disc including an optical disc body, a waterproof protective film, and a first patterned layer is provided. The optical disc body has a printable surface. The waterproof protective film has an upper surface and a lower surface. The lower surface is disposed on the printable surface, and the upper surface has an optical grating pattern or a pixel pattern. The first patterned layer is disposed between the lower surface and the printable surface.

According to the printable optical disc in an embodiment of the present invention, a thickness of the waterproof protective film is, for example, in a range of 0.02 mm to 0.2 mm.

According to the printable optical disc in an embodiment of the present invention, the thickness of the waterproof protective film is, for example, in a range of 0.025 mm to 0.06 mm.

According to the printable optical disc in an embodiment of the present invention, a material of the waterproof protective film is, for example, polycarbonate (PC), polystyrene (PS), polymethylmethacrylate (PMMA), or polyethylene terephthalate (PET).

According to the printable optical disc in an embodiment of the present invention, an adhesion layer is disposed between the lower surface and the first patterned layer.

According to the printable optical disc in an embodiment of the present invention, the adhesion layer is, for example, a pressure sensitive adhesive (PSA) layer or an ultraviolet curing layer.

According to the printable optical disc in an embodiment of the present invention, the optical grating pattern or the pixel pattern is, for example, aligned with the first patterned layer, such that the first patterned layer produces a three-dimensional effect.

According to the printable optical disc in an embodiment of the present invention, the optical disc body is, for example, a compact disc (CD), a digital versatile disc (DVD), a high definition digital versatile disc (HD-DVD), or a blu-ray disc (BD).

According to the printable optical disc in an embodiment of the present invention, the waterproof protective film, for example, has a second pattern.

A method of manufacturing a printable optical disc is also provided. The method includes the following steps: first, providing an optical disc body with a printable surface; then, providing a waterproof protective film with an upper surface having an optical grating pattern or a pixel pattern; afterward, forming a first patterned layer on the printable surface or a lower surface of the waterproof protective film; and finally, binding the printable surface and the lower surface of the waterproof protective film.

According to the method of manufacturing a printable optical disc in an embodiment of the present invention, a thickness of the waterproof protective film is, for example, in a range of 0.02 mm to 0.2 mm.

According to the method of manufacturing a printable optical disc in an embodiment of the present invention, the thickness of the waterproof protective film is, for example, in a range of 0.025 mm to 0.06 mm.

According to the method of manufacturing a printable optical disc in an embodiment of the present invention, a material of the waterproof protective film is, for example, PC, PS, PMMA, or PET.

According to the method of manufacturing a printable optical disc in an embodiment of the present invention, the waterproof protective film is formed by, for example, roll-to-roll, injection molding, or casting.

According to the method of manufacturing a printable optical disc in an embodiment of the present invention, after forming the first patterned layer and before joining the printable surface and the lower surface of the waterproof protective film, an adhesion layer is further formed on the first patterned layer.

According to the method of manufacturing a printable optical disc in an embodiment of the present invention, the adhesion layer is formed by, for example, coating.

According to the method of manufacturing a printable optical disc in an embodiment of the present invention, the adhesion layer is, for example, a PSA layer.

According to the method of manufacturing a printable optical disc in an embodiment of the present invention, the adhesion layer is, for example, an ultraviolet curing layer, and after joining the printable surface and the lower surface of the waterproof protective film, the printable optical disc is irradiated by UV-lights.

According to the method of manufacturing a printable optical disc in an embodiment of the present invention, an alignment step is further performed to align the optical grating pattern or the pixel pattern with the first patterned layer, such that the first patterned layer produces a three-dimensional effect.

According to the method of manufacturing a printable optical disc in an embodiment of the present invention, the printable surface and the lower surface of the waterproof protective film are joined through, for example, electrostatic adsorption.

According to the method of manufacturing a printable optical disc in an embodiment of the present invention, the first patterned layer is formed by, for example, an inkjet printer.

According to the method of manufacturing a printable optical disc in an embodiment of the present invention, the optical disc body is, for example, a CD, a DVD, an HD-DVD, or a BD.

According to the method of manufacturing a printable optical disc in an embodiment of the present invention, the waterproof protective film, for example, has a second pattern.

In the present invention, a waterproof protective film is disposed on a patterned layer of an optical disc body, so as to prevent the patterned layer from contacting water vapor in the air to deliquesce. Further, in the present invention, the waterproof protective film having an optical grating pattern or a pixel pattern is disposed on the patterned layer. When the patterned layer has an appropriate pattern, the optical grating pattern or the pixel pattern may be aligned with the patterned layer, such that the pattern on the patterned layer produces a three-dimensional effect.

In order to make the aforementioned and other objectives, features, and advantages of the present invention more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic cross-sectional view of a printable optical disc according to an embodiment of the present invention.

FIG. 1B is a schematic cross-sectional view of a printable optical disc according to another embodiment of the present invention.

FIG. 2 is a schematic cross-sectional view of a printable optical disc according to another embodiment of the present invention.

FIG. 3 is a flow chart of manufacturing a printable optical disc according to an embodiment of the present invention.

FIG. 4 is a flow chart of manufacturing a printable optical disc according to another embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

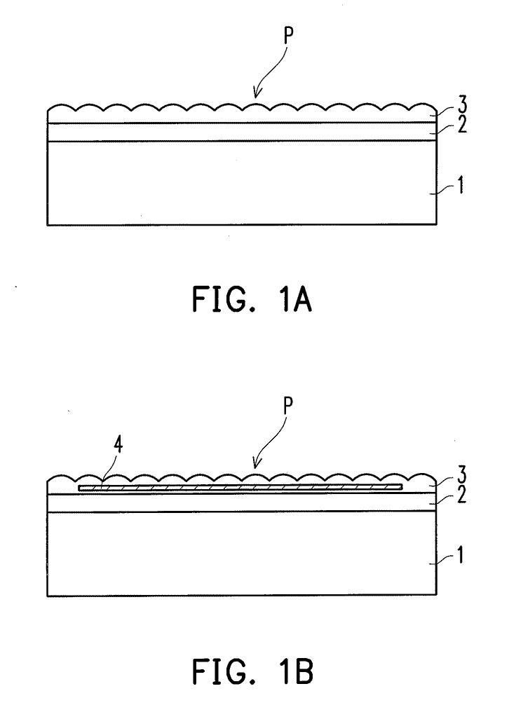

FIG. 1A is a schematic cross-sectional view of a printable optical disc according to an embodiment of the present invention.

Referring to FIG. 1A, the printable optical disc of the present invention includes an optical disc body 1, a patterned layer 2, and a waterproof protective film 3. The waterproof protective film 3 is disposed on the optical disc body 1, and the patterned layer 2 is disposed between the optical disc body 1 and the waterproof protective film 3. An upper surface of the waterproof protective film 3 has an optical grating pattern or a pixel pattern P. The optical disc body 1 is, for example, a CD, an HD-DVD, or a BD.

FIG. 1B is a schematic cross-sectional view of a printable optical disc according to another embodiment of the present invention.

Referring to FIG. 1B, the printable optical disc of this embodiment is different from the printable optical disc in FIG. 1A in that the waterproof protective film 3 has a patterned layer 4.

An HD-DVD is taken as an example below to illustrate the printable optical disc of the present invention in detail.

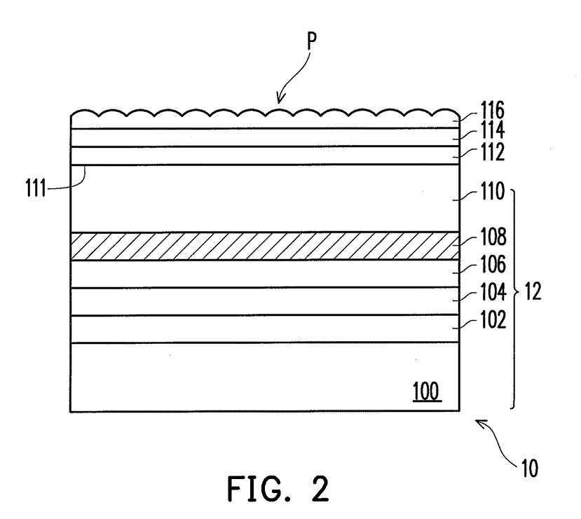

FIG. 2 is a schematic cross-sectional view of a printable optical disc according to another embodiment of the present invention.

Referring to FIG. 2, the printable optical disc 10 includes an optical disc body 12, a patterned layer 112, an adhesion layer 114, and a waterproof protective film 116. The optical disc body 12 is, for example, a HD-DVD, including substrates 100 and 110, dielectric layers 102 and 106, a recording layer 104, and a reflection layer 108. The substrate 110 is disposed above the substrate 100. The substrate 100 has a data side. The recording layer 104 is disposed between the substrates 100 and 110. The reflection layer 108 is disposed between the recording layer 104 and the substrate 110. The dielectric layer 102 is disposed between the recording layer 104 and the substrate 100. The dielectric layer 106 is disposed between the recording layer 104 and the reflection layer 108. The thicknesses and materials of the substrates 100 and 110, the dielectric layers 102 and 106, the recording layer 104, and the reflection layer 108 are well known to those of ordinary skill in the art, and will not be repeated herein again.

Again referring to FIG. 2, the optical disc body 12 has a printable surface 111. A lower surface of the waterproof protective film 116 is disposed on the printable surface 111, and an upper surface of the waterproof protective film 116 has an optical grating pattern or a pixel pattern P. A thickness of the waterproof protective film 116 is, for example, in a range of 0.02 mm to 0.2 mm, and preferably, 0.025 mm to 0.06 mm. A material of the waterproof protective film 116 is PC, PS, PMMA, or PET. The waterproof protective film 116 is formed by, for example, roll-to-roll, injection molding, or casting. The optical grating pattern or the pixel pattern P is integrally formed. That is, the optical grating pattern or the pixel pattern P is directly formed on the waterproof protective film 116 during the roll-to-roll, injection molding, or casting process. The patterned layer 112 is disposed between the lower surface of the waterproof protective film 116 and the printable surface 111. The patterned layer 112 is formed by, for example, printing ink between a waterproof protective film 116 and the printable surface 111 with an inkjet printer. For example, the patterned layer 112 may be printed on the printable surface 111 through a printing software 3D4U developed by Media Bop. The waterproof protective film 116 is disposed on the patterned layer 112, so as to prevent the pattern on the patterned layer 112 from deliquesce because of air humidity. In another embodiment, the patterned layer 112 may also be printed on the lower surface of the waterproof protective film 116.

When the patterned layer 112 has an appropriate pattern, the optical grating pattern or the pixel pattern P may be aligned with the patterned layer 112, such that the pattern of the patterned layer 112 produces a three-dimensional effect.

Further referring to FIG. 2, the adhesion layer 114 is disposed between the lower surface of the waterproof protective film 116 and the patterned layer 112 to enhance the adhesion between the lower surface of the waterproof protective film 116 and the patterned layer 112. The adhesion layer 114 is, for example, a PSA layer or an ultraviolet curing layer. Of course, in other embodiments, the adhesion layer 114 may not be formed, and the waterproof protective film 116 is directly disposed on the patterned layer 112.

The printable optical disc 10 is taken as an example below to illustrate a method of manufacturing a printable optical disc according to the present invention.

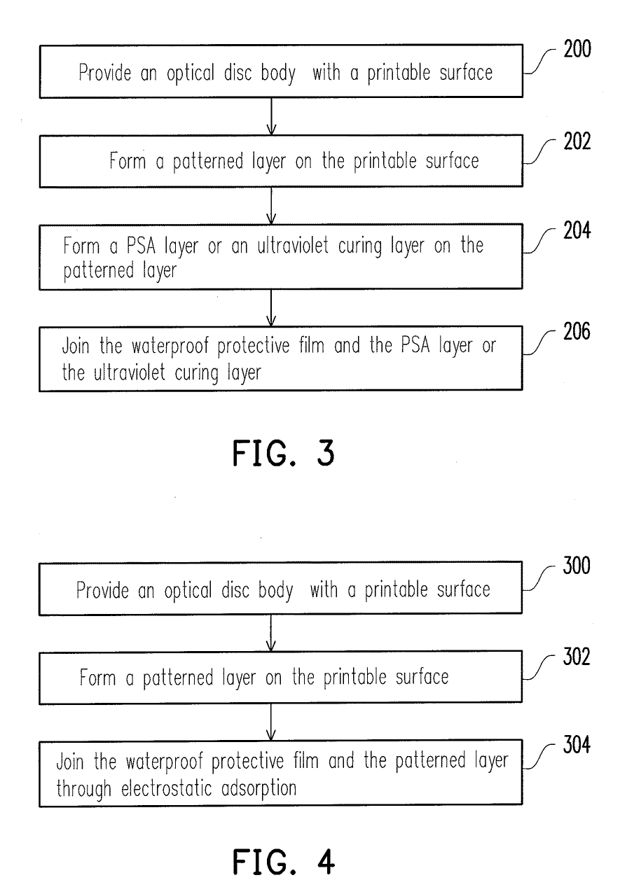

FIG. 3 is a flow chart of manufacturing a printable optical disc according to an embodiment of the present invention.

Referring to FIG. 3, firstly, in Step 200, an optical disc body 12 having a printable surface 111 is provided. The optical disc body 12 is, for example, a DVD. Similarly, in other embodiments, the optical disc body may also be a CD, an HD-DVD, or a BD.

Next, in Step 202, consumers may form a patterned layer 112 on the printable surface 111 by themselves. The patterned layer 112 is formed by, for example, printing a pattern on the printable surface 111 with an inkjet printer or by other special printing manners.

Then, in Step 204, after the consumers print a pattern on the printable surface 111 to form the patterned layer 112, an adhesion layer 114 is formed on the patterned layer 112. The adhesion layer 114 is, for example, a PSA layer or an ultraviolet curing layer. The adhesion layer 114 is formed by, for example, coating.

Later, in Step 206, a waterproof protective film 116 is provided. A lower surface of the waterproof protective film 116 is bound to the adhesion layer 114, so as to prevent the pattern on the patterned layer 112 from contacting water vapor in the air to deliquesce. In specific, when the adhesion layer 114 is a PSA layer, a pressing step is further performed on the printable optical disc 10 after the binding of the waterproof protective film 116 and the adhesion layer 114, such that the waterproof protective film 116 and the optical disc body 12 are bound more effectively. When the adhesion layer 114 is an ultraviolet curing layer, a UV-light irradiation step is performed on the printable optical disc 10 after the binding of the waterproof protective film 116 and the adhesion layer 114, such that the ultraviolet curing layer is cured to achieve the purpose of binding the waterproof protective film 116 to the optical disc body 12.

Furthermore, an upper surface of the waterproof protective film 116 has an optical grating pattern or a pixel pattern P. Therefore, the consumers may not only form the pattern with a three-dimensional effect on the printable surface 111 through, for example, the printing software 3D4U developed by Media Bop, but also first print a patterned layer 112 with an appropriate pattern on the printable surface 111 and then align the optical grating pattern or pixel pattern P of the waterproof protective film 116 with the patterned layer 112, such that the pattern of the patterned layer 112 produces a three-dimensional visual effect.

In addition, the waterproof protective film 116 is formed by, for example, roll-to-roll, injection molding, or casting. That is to say, the optical grating pattern or pixel pattern P is directly formed on the waterproof protective film 116 during the roll-to-roll, injection molding, or casting process. Therefore, the consumers may purchase the already-fabricated waterproof protective film 116 by themselves, and attach the waterproof protective film 116 to a pattern printed on the optical disc, so as to prevent the printed pattern from contacting the water vapor in the air to deliquesce.

In this embodiment, the patterned layer 112 is formed on the printable surface 111 with an inkjet printer or by other special printing manners. In another embodiment, the patterned layer 112 is formed on the lower surface of the waterproof protective film 116 with an inkjet printer or by other special printing manners, and the adhesion layer 114 is formed between the printable surface 111 and the patterned layer 112.

FIG. 4 is a flow chart of manufacturing a printable optical disc according to another embodiment of the present invention.

Referring to FIG. 4, first, in Step 300, an optical disc body 12 is provided. Next, in Step 302, the consumers may form a patterned layer 112 on the printable surface 111 by themselves. Afterward, in Step 304, a waterproof protective film 116 is directly attached to the patterned layer 112 through electrostatic adsorption. In this embodiment, the step of forming an adhesion layer 114 and the subsequent pressing step or ultraviolet irradiation step are omitted, such that the optical disc body 12 and the waterproof protective film 116 may be joined more directly and quickly.

Similarly, in this embodiment, the patterned layer 112 is formed on the printable surface 111. In another embodiment, the patterned layer 112 is formed on a lower surface of the waterproof protective film 116.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A printable optical disc, comprising:
an optical disc body, provided with a printable surface;
a waterproof protective film, provided with an upper surface and a lower surface, wherein the lower surface is disposed on the printable surface, the upper surface comprises an optical grating pattern or a pixel pattern, and a thickness of the waterproof protective film is in a range of 0.02 mm to 0.2 mm; and
a first patterned layer, disposed between the lower surface and the printable surface.

2. The printable optical disc according to claim 1, wherein the thickness of the waterproof protective film is in a range of 0.025 mm to 0.06 mm.

3. The printable optical disc according to claim 1, wherein a material of the waterproof protective film is selected form a group consisting of polycarbonate (PC), polystyrene (PS), polymethylmethacrylate (PMMA), and polyethylene terephthalate (PET).

4. The printable optical disc according to claim 1, further comprising an adhesion layer, disposed between the lower surface and the first patterned layer.

5. The printable optical disc according to claim 1, wherein the adhesion layer is a pressure sensitive adhesive (PSA) layer or an ultraviolet curing layer.

6. The printable optical disc according to claim 1, wherein the optical grating pattern or the pixel pattern is aligned with the first patterned layer, such that the first patterned layer produces a three-dimensional effect.

7. The printable optical disc according to claim 1, wherein the optical disc body is a compact disc (CD), a digital versatile disc (DVD), a high definition digital versatile disc (HD-DVD), or a blu-ray disc (BD).

8. The printable optical disc according to claim 1, wherein the waterproof protective film comprises a second pattern.

9. A method of manufacturing a printable optical disc, comprising:
providing an optical disc body with a printable surface;
providing a waterproof protective film, wherein an upper surface of the waterproof protective film comprises an optical grating pattern or a pixel pattern and a thickness of the waterproof protective film is in a range of 0.02 mm to 0.2 mm;
forming a first patterned layer on the printable surface or a lower surface of the waterproof protective film; and
joining the printable surface and the lower surface.

10. The method of manufacturing a printable optical disc according to claim 9, wherein the thickness of the waterproof protective film is in a range of 0.025 mm to 0.06 mm.

11. The method of manufacturing a printable optical disc according to claim 9, wherein the method of forming the waterproof protective film is roll-to-roll, injection molding, or casting.

12. The method of manufacturing a printable optical disc according to claim 9, further comprising a step of forming an adhesion layer on the first patterned layer, after forming the first patterned layer and before joining the printable surface and the lower surface.

13. The method of manufacturing a printable optical disc according to claim 12, wherein the adhesion layer is formed by coating.

14. The method of manufacturing a printable optical disc according to claim 12, wherein the adhesion layer is a PSA layer.

15. The method of manufacturing a printable optical disc according to claim 12, wherein the adhesion layer is an ultraviolet curing layer, and after joining the printable surface and the lower surface, the method further comprises irradiating the printable optical disc with UV-lights.

16. The method of manufacturing a printable optical disc according to claim 9, further comprising an alignment step for aligning the optical grating pattern or the pixel pattern with the first patterned layer, such that the first patterned layer produces a three-dimensional effect.

17. The method of manufacturing a printable optical disc according to claim 9, wherein the printable surface and the lower surface are joined through electrostatic adsorption.

18. The method of manufacturing a printable optical disc according to claim 9, wherein the first patterned layer is formed by an inkjet printer.

19. The method of manufacturing a printable optical disc according to claim 9, wherein the optical disc body is a CD, a DVD, an HD-DVD, or a BD.

20. The method of manufacturing a printable optical disc according to claim 9, wherein the waterproof protective film comprises a second pattern.
